(19) United States
(12) Patent Application Publication
(10) Pub. No.: US 2026/0081704 A1
(43) Pub. Date: Mar. 19, 2026

(54) OTA TEST AND/OR MEASUREMENT SYSTEM, AND OTA TESTING METHOD

(71) Applicant: Rohde & Schwarz GmbH & Co. KG, Muenchen (DE)

(72) Inventors: Mahmud NASEEF, Muenchen (DE); Goce TALAGANOV, Muenchen (DE)

(21) Appl. No.: 18/889,838

(22) Filed: Sep. 19, 2024

(51) Int. Cl. H04B 17/15; H04B 17/11; H04B 17/21; H04B 17/391

(52) U.S. Cl. CPC H04B 17/191; H04B 17/11; H04B 17/21; H04B 17/3912

(57) ABSTRACT

An over-the-air (OTA) test and/or measurement system for testing a device under test (DUT) is described. The DUT is configured to communicate with satellites. The OTA testing system includes at least one radio frequency (RF) antenna, at least one antenna positioner, and a control circuit. The RF antenna is attached to the antenna positioner. The RF antenna is configured to transmit and/or receive RF signals. The antenna positioner is configured to adapt a position of the RF antenna. The control circuit is configured to perform a satellite emulation. Performing the satellite emulation includes at least one of controlling the RF antenna to emulate a transmission characteristic of at least one satellite, controlling the RF antenna to emulate a reception characteristic of the satellite, controlling the antenna positioner to emulate a relative position between the DUT and the satellite, or controlling the antenna positioner to emulate a trajectory of the satellite.

### FIELD OF THE DISCLOSURE

Embodiments of the present disclosure generally relate to an over-the-air (OTA) test and/or measurement system for testing a device under test. Embodiments of the present disclosure further relate to an OTA testing method of testing a non-terrestrial network device under test (NTN DUT).

### BACKGROUND

Like other electronic devices, NTN communication equipment that is configured to communicate with satellites, for example satellite phones or base station antennas, needs to be tested in order to ensure a correct functionality.

Testing non-terrestrial network communication equipment with a stationary OTA may not represent a realistic use case of the NTN communication equipment, as the satellites typically move fast, which provides highly fluctuating communication conditions.

Thus, there is a need for an OTA test and/or measurement system and an OTA testing method that allow for testing NTN communication equipment under realistic conditions.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide an over-the-air (OTA) test and/or measurement system for testing a device under test (DUT). In these embodiments, the DUT is configured to communicate with satellites. In an embodiment, the OTA testing system comprises at least one radio frequency (RF) antenna, at least one antenna positioner, and a control circuit. The at least one RF antenna is attached to the at least one antenna positioner, wherein the at least one RF antenna is configured to transmit and/or receive RF signals. The at least one antenna positioner is configured to adapt a position of the at least one RF antenna. The control circuit is configured to perform a satellite emulation, wherein performing the satellite emulation comprises at least one of controlling the at least one RF antenna to emulate a transmission characteristic of at least one satellite, controlling the at least one RF antenna to emulate a reception characteristic of the at least one satellite, controlling the at least one antenna positioner unit to emulate a relative position between the DUT and the at least one satellite, or controlling the at least one antenna positioner to emulate a trajectory of the at least one satellite.

The term “position” is understood to denote a location and/or orientation, for example both location and orientation. The position may be measured in any suitable coordinate system, e.g. in terms of a latitude angle, a longitude angle, and an altitude.

The term “relative position between the DUT and the satellite” is understood to denote a relative position between the satellite and a specific position of the DUT on earth. In an embodiment, the specific position of the DUT may be the actual position of the DUT on earth. However, it is also conceivable that the specific position of the DUT may be set to a desired position for testing the DUT.

In an embodiment, the at least one satellite emulated by the OTA test and/or measurement system may be or comprise at least one low earth orbit satellite, at least one middle earth orbit satellite, and/or at least one geostationary satellite.

The OTA test and/or measurement system is based on the idea to provide a realistic environment for testing the DUT by emulating the at least one satellite, namely emulating communication characteristics and/or movement characteristics of the at least one satellite. This allows to assess a performance of the device under test in a realistic use case, i.e. the assessed performance is actually reached by the DUT when communicating with an actual satellite.

For example, an uplink performance of the DUT and/or a downlink performance of the DUT can be assessed. Thus, a comprehensive analysis of the performance of the DUT can be provided.

According to an aspect of the present disclosure, the control circuit, for example, is configured to perform the satellite emulation for a predefined time period. In an embodiment, the predetermined time period may be a time period in the past, in the presence, and/or in the future. This allows to test the DUT for different (sets of) satellites being visible from the location of the DUT at different time periods. Accordingly, the DUT can be tested for a large variety of different realistic use cases.

In an embodiment of the present disclosure, the control circuit is configured to perform satellite emulations of a predefined set of satellites simultaneously. Thus, the performance of the DUT can be assessed in scenarios where multiple satellites are visible to the DUT at the same time, which is a typical use case for NTN DUTs.

According to another aspect of the present disclosure, the OTA test and/or measurement system comprises, for example, a plurality of antenna positioners and a plurality of RF antennas, wherein the control circuit is configured to control the plurality of antenna positioners and/or the plurality of RF antennas to emulate the predefined set of satellites simultaneously. Providing a plurality of antenna positioners and a plurality of RF antennas allows to emulate a plurality of satellites independently of each other.

In an embodiment, a predefined number of RF antennas may be attached to each antenna positioner. For example, one, two, or four RF antennas may be attached to each antenna positioner.

In another embodiment, the control circuit is configured to control the plurality of antenna positioners to move collision-free. This ensures a correct and uninterrupted emulation of trajectories of different satellites.

An aspect of the present disclosure provides that the control circuit, for example, is configured to perform the satellite emulation for a predefined time period, wherein the predefined set of satellites comprises only satellites being visible for the DUT in the predefined time period. Accordingly, the control circuit may be configured to determine which satellites are visible for the DUT in the predefined time period, for example based on a database comprising position data with information on positions of a plurality of satellites.

According to an aspect of the present disclosure, the control circuit, for example, is configured to control the at least one antenna positioner and/or the at least one RF antenna to emulate at least one of an altitude of the at least one satellite, an elevation angle of the at least one satellite, an azimuth of the at least one satellite, a propagation delay between the at least one satellite and the DUT, a path loss for an RF signal travelling from the at least one satellite to the DUT, a path loss for an RF signal travelling from the DUT to the at least one satellite, a Doppler shift caused by a velocity of the at least one satellite, or a Doppler rate caused by the velocity of the at least one satellite. Thus, a precise assessment of the performance of the DUT is ensured, as the at least one satellite and/or a transmission path between the at least one satellite and the DUT is emulated correctly.

In an embodiment, the control circuit may be configured to emulate a fading profile of the at least one satellite.

In an embodiment, the OTA test and/or measurement system may further comprise an analysis circuit, wherein the analysis circuit is configured to analyze an RF signal received by the at least one RF antenna from the DUT and/or an RF signal received by the DUT from the at least one RF antenna. In other words, the analysis circuit may be configured to analyze an uplink performance of the DUT by analyzing the RF signal received by the at least one RF antenna from the DUT. Alternatively or additionally, the analysis circuit may be configured to analyze a downlink performance of the DUT by analyzing the RF signal received by the DUT from the at least one RF antenna.

In an embodiment, the RF signal received by the DUT from the at least one RF antenna is processed by the DUT before analysis by the analysis circuit. For example, the RF signal received by the DUT may be processed by a suitable RF frontend of the DUT, i.e. a frequency conversion may be performed by the DUT. Further, the RF signal received by the DUT may be processed by filters and/or other electronic circuits of the DUT.

In an embodiment, the analysis circuit is configured to determine at least one performance parameter of the DUT based on the RF signal received by the at least one RF antenna from the DUT and/or based on the RF signal received by the DUT from the at least one RF antenna. In general, the at least one performance parameter is indicative of a performance of the device under test, e.g. an uplink performance and/or a downlink performance of the DUT.

For example, the at least one performance parameter may comprise an error vector magnitude (EVM), an adjacent channel leakage ratio (ACLR), a modulation error ratio (MER), a signal to noise ratio (SNR), a carrier frequency error, an IQ offset, an IQ imbalance, an IQ skew, a gain imbalance, a quadrature error, an amplitude droop, a magnitude error, a phase error, and/or a power level of the respective RF signal. However, it is to be understood that the at least one performance parameter may comprise any other suitable parameter for assessing the performance of the device under test.

According to an aspect of the present disclosure, the at least one antenna positioner, for example, comprises a robot arm or a gantry. Accordingly, the at least one RF antenna is brought into the correct position(s) for emulating the at least one satellite by the robot arm or by the gantry.

According to a further aspect of the present disclosure, the at least one antenna positioner, for example, comprises an unmanned aerial vehicle (UAV). Accordingly, the at least one RF antenna is brought into the correct position(s) for emulating the at least one satellite by the UAV.

In an embodiment, the OTA test and/or measurement system may further comprise a DUT positioner, wherein the DUT positioner is configured to hold the device under test in predefined position. In an embodiment, the DUT positioner may be configured to adapt the position of the DUT. For example, the DUT positioner may be configured to adapt an orientation of the DUT, i.e. an elevation angle and/or an azimuth angle of the DUT. Thus, the DUT can be tested for different orientations of the DUT.

In an embodiment, the control circuit is configured to access a database. The database may comprise position data with information on positions of a plurality of satellites. The control circuit is configured to perform the satellite emulation based on the position data. In an embodiment, the database may comprise information on the positions of the plurality of satellites over time. Thus, the database allows a precise emulation the at least one satellite with the correct position and/or correct trajectory of the at least one satellite.

In another embodiment, the control circuit is configured to determine trajectories of the plurality of satellites based on the position data. For example, the trajectories may be determined by the control circuit based on the position data by using perturbation theory or another suitable technique.

In an embodiment, the trajectories may be determined based on the position data by the control circuit using a simplified perturbation model, such as SGP, SGP4, SDP4, SGP8, or SDP8, which are models used to calculate orbital state vectors of satellites and space debris relative to an earth-centered inertial coordinate system.

According to an aspect of the present disclosure, the control circuit, for example, is configured to determine, based on the trajectories determined, at least one of an altitude of the at least one satellite, an elevation angle of the at least one satellite, an azimuth of the at least one satellite, a propagation delay between the at least one satellite and the DUT, a path loss for an RF signal travelling from the at least one satellite to the DUT, a path loss for an RF signal travelling from the DUT to the at least one satellite, a Doppler shift caused by a velocity of the at least one satellite, or a Doppler rate caused by the velocity of the at least one satellite. Thus, a precise assessment of the performance of the DUT is ensured, as the at least one satellite is emulated correctly.

In an embodiment, the OTA test and/or measurement system may further comprise a visualization circuit, wherein the visualization circuit is configured to generate visualization data associated with at least one of a position of the at least one satellite, or a trajectory of the at least one satellite. Thus, the position of the at least one satellite, for example the position of a plurality of satellites, is presented to an user of the OTA test and/or measurement system in an illustrative way.

In an embodiment, the visualization circuit may be configured to generate visualization data in an Earth-centered, Earth-fixed (ECEF), Cartesian format. The ECEF Cartesian format is based on the Earth-centered, Earth-fixed coordinate system, also known as the geocentric coordinate system, which is a Cartesian spatial reference system that represents locations in the vicinity of the Earth as X, Y, and Z measurements from its center of mass. Accordingly, the trajectory of the at least one satellite can be found based on the data in ECEF Cartesian format by scaling down from real to the maximum reach of the antenna positioner, for example the robot arm.

In an embodiment, the OTA test and/or measurement system may further comprise a user interface, wherein the user interface is configured to receive a user input from a user, wherein the control circuit is configured to perform the satellite emulation based on the user input. Accordingly, a user may select and/or configure the tests to be performed on the DUT via the user interface.

For example, the user may select the predefined time period described above and/or a set of satellites to be emulated via the user interface.

Another aspect of the present disclosure provides that the DUT, for example, is a non-terrestrial network (NTN) device. For example, the DUT may be a satellite phone, a mobile phone, a navigation device based on a global satellite navigation system, or a base station antenna. However, it is to be understood that the DUT may be established as any other type of NTN device.

Embodiments of the present disclosure further provide an over-the-air (OTA) testing method of testing a non-terrestrial network device under test (NTN DUT). In an embodiment, the OTA testing method comprises providing the NTN DUT and placing the NTN DUT in a measurement zone; providing at least one antenna positioner with at least one radio frequency, RF, antenna being attached to the at least one antenna positioner, he at least one RF antenna is configured to transmit and/or receive RF signals; and controlling, by a control circuit, the at least one antenna positioner and/or the at least one RF antenna to perform a satellite emulation.

In an embodiment, performing the satellite emulation comprises at least one of controlling the at least one RF antenna to emulate a transmission characteristic of at least one satellite, controlling the at least one RF antenna to emulate a reception characteristic of the at least one satellite, controlling the at least one antenna positioner unit to emulate a relative position between the DUT and the satellite, or controlling the at least one antenna positioner to emulate a trajectory of the at least one satellite.

The OTA test and/or measurement system according to any one of the embodiments described above may be configured to perform any one of the embodiments of the OTA testing methods described herein, at least partially.

Regarding the further advantages and properties of the OTA testing method, reference is made to the explanations given above with respect to the OTA test and/or measurement system, which also hold for the OTA testing method and vice versa.

According to an aspect of the present disclosure, the satellite emulation, for example, is performed for a predefined set of satellites for a predefined time period. Therein, the predetermined time period may be a time period in the past, in the presence, and/or in the future. This allows to test the DUT for different sets of satellites being visible from the location of the DUT at different time periods. Accordingly, the DUT can be testes for a large variety of different realistic use cases. In an embodiment, the performance of the DUT can be assessed in scenarios where multiple satellites are visible to the DUT at the same time, is a typical use case for NTN DUTs.

For example, the predefined set of satellites may comprise only satellites being visible for the DUT in the predefined time period.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an OTA test and/or measurement system according to an embodiment of the present disclosure;

FIG. 2 schematically shows another embodiment of OTA test and/or measurement system of FIG. 1;

FIG. 3 schematically shows a cross section through a portion of a robot arm comprising RF antennas;

FIG. 4 shows an example flow chart of an OTA testing method according to an embodiment of the present disclosure;

FIG. 5 shows diagrams illustrating different parameters being emulated by the OTA test and/or measurement system of FIG. 1 or 2;

FIG. 6 shows example measurement results obtained by the OTA test and/or measurement system of FIG. 1 or 2;

FIG. 7 shows examples of two different plots illustrating satellite positions;

FIG. 8 shows a plot illustrating satellite positions with color-coded altitude; and

FIG. 9 shows a plot illustrating visibility of a satellite from a location of a device under test.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

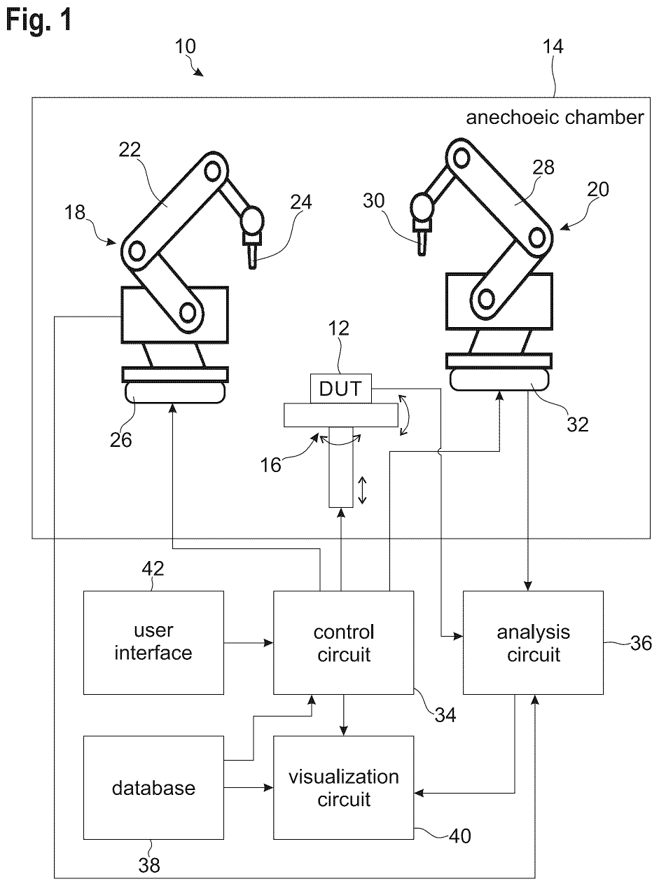

FIG. 1 schematically shows an example of an over-the-air, OTA, test and/or measurement system 10. In general, the OTA test and/or measurement system 10 is configured to perform tests on a non-terrestrial network device under test 12, abbreviated NTN DUT, that is configured to communicate with satellites. For example, the NTN DUT 12 may be a satellite phone, a mobile phone, a navigation device based on a global satellite navigation system, or a base station antenna.

As shown in the embodiment of FIG. 1, the OTA test and/or measurement system 10 comprises an anechoic chamber 14 that is configured to shield an interior of the anechoic chamber 14 from external electromagnetic radiation. Further, the anechoic chamber 14 may comprise dampening means such as absorbers that may be provided on inside walls of the anechoic chamber 14 in order to avoid undesired reflections within the anechoic chamber 14.

Inside of the anechoic chamber 14, an optional DUT positioner 16 is provided. The DUT positioner 16 is configured to hold the DUT 12 in an adaptable position. In the example embodiment shown in FIG. 1, the DUT positioner 16 is configured to adapt a height, an azimuth angle, and/or an elevation angle of the DUT 12. In an embodiment, the DUT positioner 16 may include one or more controllable linear stages, rotation tables, etc. However, it is to be understood that any other suitable type of DUT positioner may be provided.

With continued reference to FIG. 1, the OTA test and/or measurement system 10 further comprises a first antenna positioner 18 as well as a second antenna positioner 20 that are both provided inside the anechoic chamber 14. In the embodiment shown in FIG. 1, the first antenna positioner 18 comprises a first robot arm 22 that is configured to hold at least one first RF antenna 24 in an adaptable position. Further, the first antenna positioner 18 may comprise movement means 26 that allow the first robot arm 22 to move within the anechoic chamber 14. For example, the movement means 26 may comprise at least one of tracks, tires, a conveyor belt, one or more linear stage(s), an XY table, or any other suitable type of movement means.

In the embodiment shown, the second antenna positioner 20 comprises a second robot arm 28 that is configured to hold at least one second RF antenna 30 in an adaptable position. Further, the second antenna positioner 20 may comprise movement means 32 that allow the second robot arm 28 to move within the anechoic chamber 14. The movement means 32 may be configured as and/or include any of the apparatus described above with respect movement means 26.

It is to be understood that while FIG. 1 shows a representative case of two antenna positioners 18, 20 and two RF antennas 24, 30, the OTA test and/or measurement system 10 may comprise any other arbitrary number of antenna positioners and/or any other arbitrary number of RF antennas. Moreover, instead or in addition to the robot arms 22, 28, the antenna positioners 18, 20 may comprise gantries being configured to hold the RF antennas 24, 30 in the adaptable position.

In an embodiment, the OTA test and/or measurement system 10 further comprises a control circuit 34 that is connected to the antenna positioners 18, 20 as well as to the RF antennas 24, 30 in a signal-transmitting manner. Further, the control circuit 34 may be connected to the optional DUT positioner 16 in a signal-transmitting manner. Alternatively or additionally, the control circuit 34 may be connected to the DUT 12 in a signal-transmitting manner. In an embodiment, the OTA test and/or measurement system 10 further comprises an analysis circuit 36 that is connected to the RF antennas 24, 30 and/or to the DUT 12 in a signal-transmitting manner.

The term “connected in a signal-transmitting manner” is understood to denote a cable-based and/or wireless connection that is configured to transmit signals between the respective devices or components.

In an embodiment, the OTA test and/or measurement system 10 may further comprises a database 38 that is connected at least to the control circuit 34. Alternatively, the control circuit 34 may be connectable to a database that is external to the OTA test and/or measurement system 10, for example via the Internet.

In an embodiment, a visualization circuit 40 is provided. The visualization circuit 40 is connected to the control circuit 34, the analysis circuit 36, and/or database 38. In an embodiment, the OTA test and/or measurement system 10 may further comprise a user interface 42 that is connected at least to the control circuit 34.

It is noted that the control circuit 34, the analysis circuit 36, the visualization circuit 40, and/or the user interface 42 may be integrated into a computer device, for example into a personal computer, a laptop, a notebook, a smartphone, a tablet, or any other suitable type of smart device. In an embodiment, the computer device may further comprise the database 38 or may be connectable to the database 38.

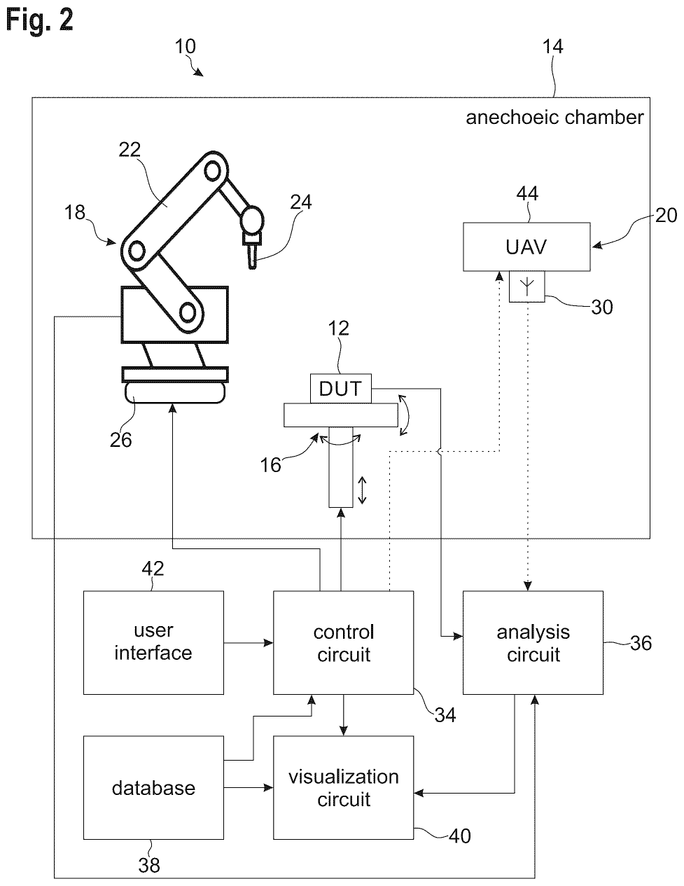

FIG. 2 shows another embodiment of the OTA test and/or measurement system 10, wherein only the differences compared to the embodiment described above regarding FIG. 1 are explained hereinafter. In the embodiment shown in FIG. 2, the second antenna positioner 20 is established as an unmanned aerial vehicle (UAV) 44 with the at least one second RF antenna 30 being attached to the UAV 44. The UAV 44 may be an unmanned multi-copter or another suitable type of UAV that can be stationary in the air. It is to be understood that the first antenna positioner 18 may also be replaced by an UAV. Likewise, it is to be understood that the OTA test and/or measurement system 10 may comprise more than two UAVs, and accordingly more than two RF antennas.

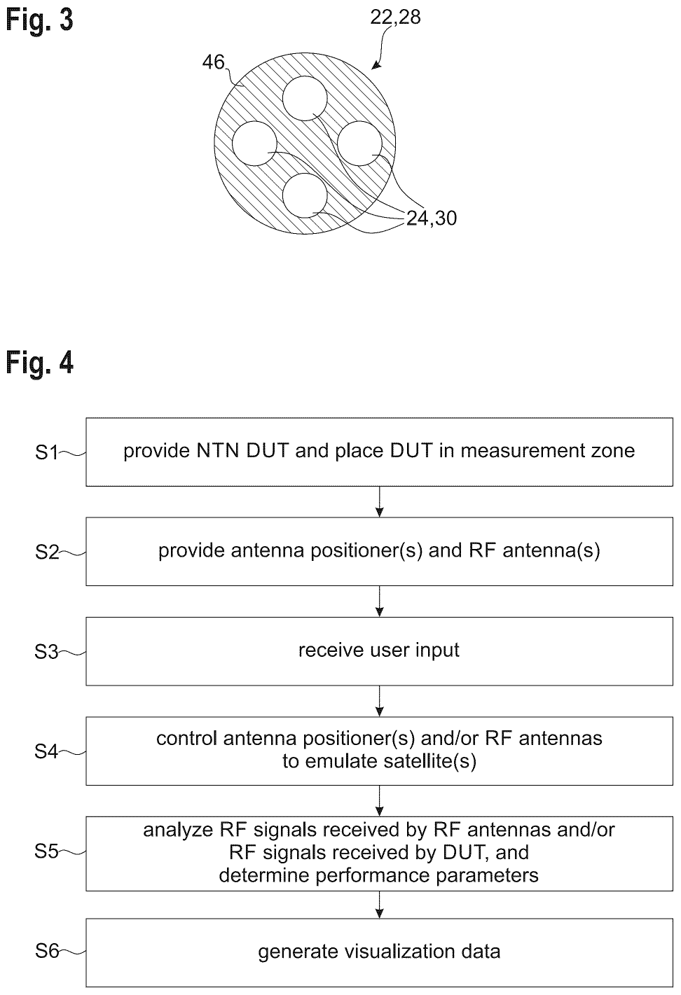

FIG. 3 shows a cross section of a portion of the first robot arm 22 or of the second robot arm 28 comprising the at least one first RF antenna 24 or the at least one second RF antenna 30 in more detail. In the embodiment shown in FIG. 3, the first robot arm 22 may comprise four first RF antennas 24 that are separated from each other by an absorber portion 46. Likewise, the second robot arm 28 may comprise four second RF antennas 30 that are separated from each other by an absorber portion 46. In an embodiment, the absorber portion 46 may comprise or consist of an RF wave absorbing material, such that the absorber portion 46 prevents unintended interactions between different RF antennas.

The OTA test and/or measurement system 10 is configured to perform an OTA testing method of testing the NTN DUT 12, an example of which is described hereinafter with reference to FIG. 4.

The NTN DUT 12 is provided and placed in a measurement zone of the OTA test and/or measurement system 10, namely on the DUT positioner 16 within the anechoic chamber 14 (step S1).

If not already present in the OTA test and/or measurement system 10, the antenna positioner(s) 18, 20 with the corresponding RF antennas 24, 30 are provided, namely inside the anechoic chamber 14 (step S2).

A user input is received via the user interface 42 (step S3). In general, the user input relates to a test to be conducted on the DUT 12. In other words, the user may select and/or configure tests to be conducted by the OTA test and/or measurement system 10 via the user interface 42.

Based on the selected and/or configured tests to be conducted, the control circuit 34 controls the OTA test and/or measurement system 10 to perform the selected and/or configured tests (step S4). In an embodiment, the control circuit 34 controls the first antenna positioner 18, the second antenna positioner 20, the at least one first RF antenna 24, and/or the at least one second RF antenna 30 to emulate at least one satellite according to the selected and/or configured tests.

For example, performing the satellite emulation comprises at least one of controlling the RF antennas 24, 30 to emulate a transmission characteristic of the at least one emulated satellite, controlling the RF antennas 24, 30 to emulate a reception characteristic of the at least one emulated satellite, controlling the antenna positioners 18, 20 to emulate a relative position between the DUT and the at least one emulated satellite, or controlling the antenna positioners 18, 20 to emulate a trajectory of the at least one satellite.

Emulating the transmission characteristic of the at least one emulated satellite may comprise generating an RF signal, modulating the RF signal appropriately, and transmitting the modulated RF signal to the DUT 12 with appropriate directivity. Emulating the reception characteristics of the at least one emulated satellite may comprise receiving the RF signal from the DUT 12 with appropriate directivity, and demodulating the RF signal appropriately.

In an embodiment, the control circuit 34 may access the database 38 that comprises position data with information on positions of a plurality of satellites. The database 38 may be updated regularly with current positions of the plurality of satellites, such that the database 38 comprises information on the positions of the plurality of satellites over time.

In an embodiment, the control circuit 34 may perform the emulation for a predefined set of satellites simultaneously and/or consecutively. This predefined set of satellites may be satellites that have been selected by the user, namely by the user input received.

Alternatively or additionally, the predefined set of satellites may be satellites that are visible for the DUT 12, as seen from the location of the DUT 12, in a predefined time period. In general, the predefined time period may be a time period in the past, in the present, or in the future. In an embodiment, the user may select the predefined time period for which the satellite emulation is to be performed by providing the user input.

In an embodiment, the control circuit 34 may automatically determine which satellites are visible for the DUT 12 in the selected predefined time period.

As already mentioned above, in order to emulate the at least one satellite to be emulated, the control circuit 34 accesses the database 38 and obtains the position data with information on positions of the satellite(s) to be emulated. Based on the position data comprised in the database 38, the control circuit 34 may determine trajectories of the respective satellites, for example by applying a simplified perturbation model, such as SGP, SGP4, SDP4, SGP8, or SDP8.

Based on the trajectories determined, the control circuit 34 controls the antenna positioners 18, 20 and/or the RF antennas 24, 30 to correctly emulate one, more, or all of the following properties of the at least one emulated satellite: an altitude of the at least one satellite, an elevation angle of the at least one satellite, an azimuth of the at least one satellite, a propagation delay between the at least one satellite and the DUT 12, a path loss for an RF signal travelling from the at least one satellite to the DUT 12, a path loss for an RF signal travelling from the DUT 12 to the at least one satellite, a Doppler shift caused by a velocity of the at least one satellite, or a Doppler rate caused by the velocity of the at least one satellite.

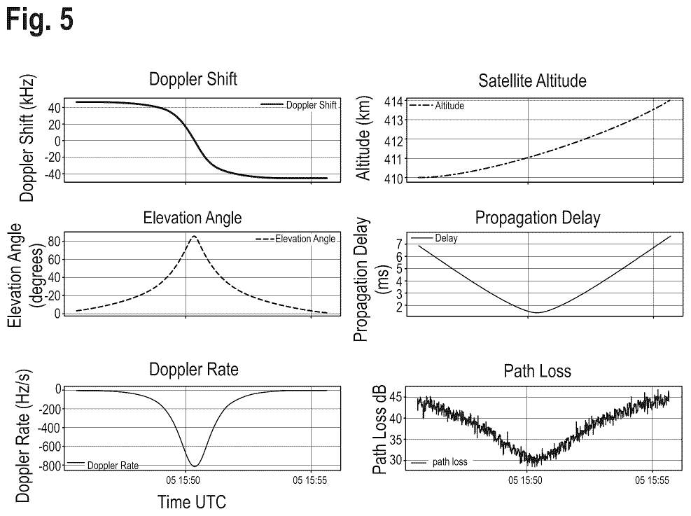

FIG. 5 schematically illustrates examples of these quantities determined by the control circuit 34, and how these quantities vary over time due to the changing relative position of the satellite with respect to the DUT 12 and due to the changing relative velocity between the satellite and the DUT 12.

Position-related properties of the at least one emulated satellite are emulated by the antenna positioners 18, 20, namely by positioning the RF antennas 24, 30 such that the positions of the RF antennas 24, 30 resemble the emulated position of the at least one satellite. In an embodiment, the positions or trajectories of different satellites may be emulated simultaneously by different antenna positioners 18, 20. The control circuit 34 may be configured to avoid collisions between the antenna positioners 18, 20 in order to guarantee an uninterrupted emulation of the at least one satellite.

Communication signal-related properties of the at least one emulated satellite are emulated by the RF antennas 24, 30, namely by appropriately adjusting signal parameters such as signal level, signal frequency, signal phase, i.e. signal delay, and/or signal noise content.

RF signals received by the RF antennas 24, 30 from the DUT 12 and/or RF signals received by the DUT 12 from the RF antennas 24, 30 are analyzed by the analysis circuit 36 (step S5). For example, the analysis circuit 36 determines at least one performance parameter of the DUT 12 based on the RF signals analyzed.

In the case of the RF signals received by the RF antennas 24, 30 being analyzed, the at least one determined performance parameter relates to an uplink performance of the DUT 12. In the case of the RF signals received by the DUT 12 being analyzed by the analysis circuit 36, the at least one determined performance parameter relates to a downlink performance of the DUT 12.

For example, the at least one performance parameter may comprise an error vector magnitude (EVM), an adjacent channel leakage ratio (ACLR), a modulation error ratio (MER), a signal to noise ratio (SNR), a carrier frequency error, an IQ offset, an IQ imbalance, an IQ skew, a gain imbalance, a quadrature error, an amplitude droop, a magnitude error, a phase error, and/or a power level of the respective RF signal.

Visualization data may be generated by the visualization circuit 40 based on the analysis of the RF signal(s) and/or based on the at least one performance parameter determined (step S6). The visualization data generated may be displayed on a display of the OTA test and/or measurement system 10.

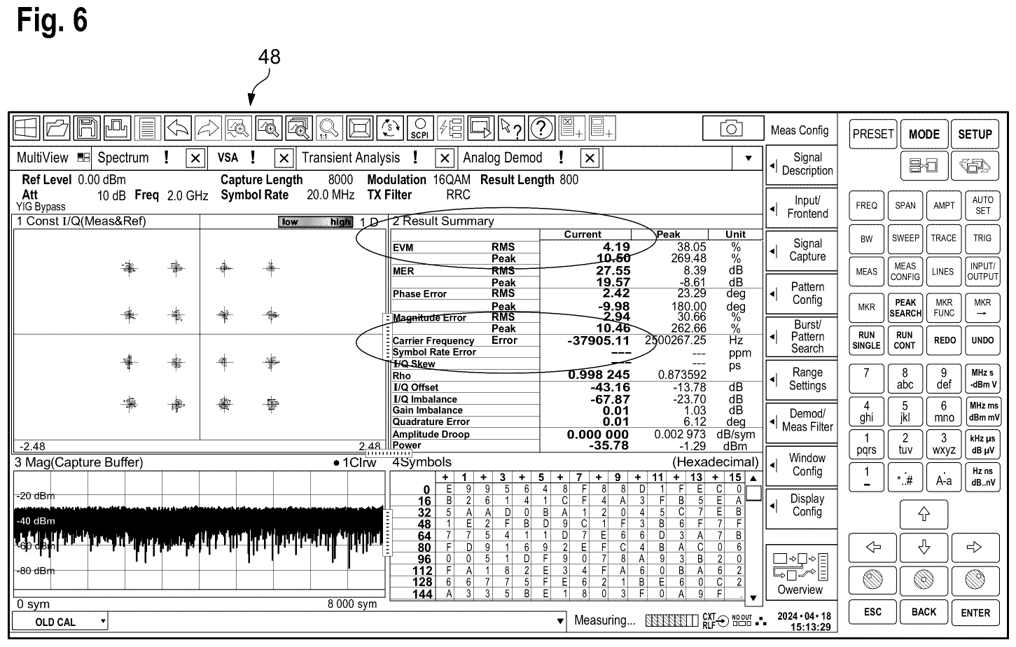

An example visualization provided by the visualization circuit 40 is depicted in FIG. 6, which shows a display 48 of the OTA test and/or measurement system 10 displaying the visualization data described above. However, it is to be understood that generating visualization data by the visualization circuit 40 is not restricted only to providing the visualization data with respect to the measurement results obtained by the analysis circuit 36.

In an embodiment, the visualization circuit 40 may also generate visualization data associated with the information saved in the database 38, namely regarding the position data saved in the database 38. This way, the user is assisted in choosing an appropriate set of satellites to be emulated.

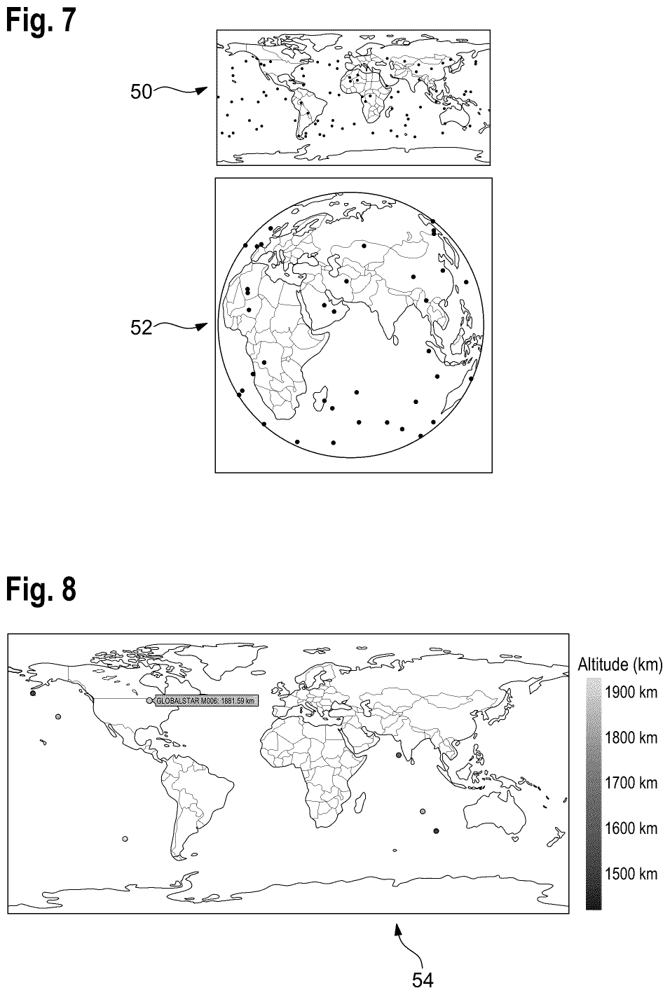

As is illustrated in FIG. 7, the visualization data generated by the visualization circuit 40 may comprise a two-dimensional plot 50 of the positions of the respective satellites, and/or a three-dimensional plot 52 of the positions of the respective satellites.

In an embodiment, the user may select a set of satellites via the user interface 42, and their corresponding positions may be visualized.

As a further example illustrated in FIG. 8, the visualization data generated by the visualization circuit 40 may comprise a color-coded altitude plot 54 of at least a predefined set of satellites, for example of a predefined set of satellites selected by the user.

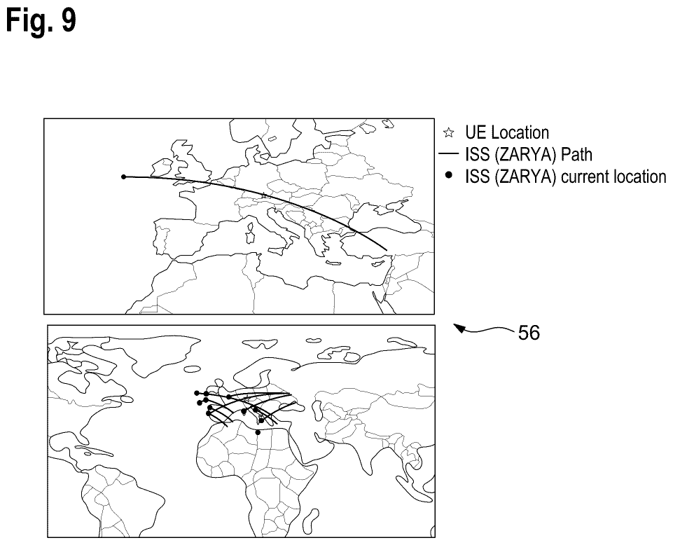

As a further example illustrated in FIG. 9, the visualization data generated by the visualization circuit 40 may comprise a plot 56 illustrating the visibility of the respective satellite(s) from the current location of the DUT 12 (“UE” in FIG. 9).

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the control circuit 34, the analysis circuit 36, the database 38, the visualization circuit 40, the user interface 42, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein, etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. An over-the-air, OTA, test and/or measurement system for testing a device under test, DUT, wherein the DUT is configured to communicate with satellites, the OTA testing system comprising:
at least one antenna positioner;
at least one RF antenna configured to transmit and/or receive RF signals, the at least one RF antenna attached to the at least one antenna positioner, wherein the at least one antenna positioner is configured to adapt a position of the at least one RF antenna; and
a control circuit configured to perform a satellite emulation, wherein performing the satellite emulation comprises at least one of controlling the at least one RF antenna to emulate a transmission characteristic of at least one satellite, controlling the at least one RF antenna to emulate a reception characteristic of the at least one satellite, controlling the at least one antenna positioner unit to emulate a relative position between the DUT and the at least one satellite, or controlling the at least one antenna positioner to emulate a trajectory of the at least one satellite.

2. The OTA test and/or measurement system of claim 1, wherein the control circuit is configured to perform the satellite emulation for a predefined time period.

3. The OTA test and/or measurement system of claim 1, wherein the control circuit is configured to perform satellite emulations of a predefined set of satellites simultaneously.

4. The OTA test and/or measurement system of claim 3, further comprising a plurality of antenna positioners and a plurality of RF antennas, wherein the control circuit is configured to control the plurality of antenna positioners and/or the plurality of RF antennas to emulate the predefined set of satellites simultaneously.

5. The OTA test and/or measurement system of claim 4, wherein the control circuit is configured to control the plurality of antenna positioners to move collision-free.

6. The OTA test and/or measurement system of claim 3, wherein the control circuit is configured to perform the satellite emulation for a predefined time period, wherein the predefined set of satellites comprises only satellites being visible for the DUT in the predefined time period.

7. The OTA test and/or measurement system of claim 1, wherein the control circuit is configured to control the at least one antenna positioner and/or the at least one RF antenna to emulate at least one of an altitude of the at least one satellite, an elevation angle of the at least one satellite, an azimuth of the at least one satellite, a propagation delay between the at least one satellite and the DUT, a path loss for an RF signal travelling from the at least one satellite to the DUT, a path loss for an RF signal travelling from the DUT to the at least one satellite, a Doppler shift caused by a velocity of the at least one satellite, or a Doppler rate caused by the velocity of the at least one satellite.

8. The OTA test and/or measurement system of claim 1, further comprising an analysis circuit, wherein the analysis circuit is configured to analyze an RF signal received by the at least one RF antenna from the DUT and/or an RF signal received by the DUT from the at least one RF antenna.

9. The OTA test and/or measurement system of claim 8, wherein the analysis circuit is configured to determine at least one performance parameter of the DUT based on the RF signal received by the at least one RF antenna from the DUT and/or based on the RF signal received by the DUT from the at least one RF antenna.

10. The OTA test and/or measurement system of claim 1, wherein the at least one antenna positioner comprises a robot arm or a gantry.

11. The OTA test and/or measurement system of claim 1, wherein the at least one antenna positioner comprises an unmanned aerial vehicle (UAV).

12. The OTA test and/or measurement system of claim 1, further comprising a DUT positioner, wherein the DUT positioner is configured to hold the device under test in predefined position.

13. The OTA test and/or measurement system of claim 1, wherein the control circuit is configured to access a database, the database comprising position data with information on positions of a plurality of satellites, and wherein the control circuit is configured to perform the satellite emulation based on the position data.

14. The OTA test and/or measurement system of claim 13, wherein the control circuit is configured to determine trajectories of the plurality of satellites based on the position data.

15. The OTA test and/or measurement system of claim 14, wherein the control circuit is configured to determine, based on the trajectories determined, at least one of an altitude of the at least one satellite, an elevation angle of the at least one satellite, an azimuth of the at least one satellite, a propagation delay between the at least one satellite and the DUT, a path loss for an RF signal travelling from the at least one satellite to the DUT, a path loss for an RF signal travelling from the DUT to the at least one satellite, a Doppler shift caused by a velocity of the at least one satellite, or a Doppler rate caused by the velocity of the at least one satellite.

16. The OTA test and/or measurement system of claim 1, further comprising a visualization circuit, wherein the visualization circuit is configured to generate visualization data associated with at least one of a position of the at least one satellite, or a trajectory of the at least one satellite and/or wherein the visualization circuit is configured to generate visualization data in an Earth-centered, Earth-fixed Cartesian format.

17. The OTA test and/or measurement system of claim 1, further comprising a user interface, wherein the user interface is configured to receive a user input from a user, wherein the control circuit is configured to perform the satellite emulation based on the user input.

18. The OTA test and/or measurement system of claim 1, wherein the DUT is a non-terrestrial network (NTN) device.

19. An over-the-air, OTA, testing method of testing a non-terrestrial network device under test (NTN) DUT, the OTA testing method comprising:
providing the NTN DUT and placing the NTN DUT in a measurement zone;
providing at least one antenna positioner with at least one radio frequency, RF, antenna being attached to the at least one antenna positioner, he at least one RF antenna is configured to transmit and/or receive RF signals; and
controlling, by a control circuit, the at least one antenna positioner and/or the at least one RF antenna to perform a satellite emulation;
wherein performing the satellite emulation comprises at least one of controlling the at least one RF antenna to emulate a transmission characteristic of at least one satellite, controlling the at least one RF antenna to emulate a reception characteristic of the at least one satellite, controlling the at least one antenna positioner unit to emulate a relative position between the DUT and the satellite, or controlling the at least one antenna positioner to emulate a trajectory of the at least one satellite.

20. The OTA testing method of claim 19, wherein the satellite emulation is performed for a predefined set of satellites for a predefined time period.
